(19) United States
(12) Patent Application Publication
(10) Pub. No.: US 2015/0006469 A1
(43) Pub. Date: Jan. 1, 2015

(54) Methodology supported business intelligence (BI) software and system

(71) Applicant: Bi-Builders AS, Sandnes (NO)

(72) Inventor: Erik Frafjord, Sandnes (NO)

(21) Appl. No.: 14/488,076

(22) Filed: Sep. 16, 2014

Related U.S. Application Data
(62) Division of application No. 14/117,856, filed on Nov. 15, 2013.
Application No. 14/117,856 is a continuation of application No. PCT/IB2013/054191, filed on May 22, 2013.
(60) Provisional application No. 61/650,738, filed on May 23, 2012.

(51) Int. Cl. G06F 17/30

(52) U.S. Cl. CPC G06F 17/30563
USPC 707/602

(57) ABSTRACT

The disclosed device provides idealized and reusable data source interfaces. The process of idealizing includes reengineering of an original data model using a surrogate key based model. The technique emphasizes readability and performance of the resulting operational data store. In, addition, the disclosed device provides a unique method for handling changes which allows for all types of changes to be automatically implemented in the operational data store by table conversion. Further the disclosed device provides inline materialization which supports a continuous data flow dependency chain. A continuous dependency chain is used to provide automated documentation as well as a dynamic paralleled transformation process.

### CROSS REFERENCE APPLICATIONS

This application is a divisional of application Ser. No. 14/117,856 filed Nov. 15, 2013 which is a section 371 national stage of international application no. PCT/IB2013/054254, filed May 23, 2013 and claiming the benefit of provisional application No. 61/650,738 filed May 23, 2012, and international application no. PCT/IB2013/054191 filed May 22, 2013, all the disclosures of which are hereby incorporated by reference in its entirety.

### TECHNICAL FIELD OF ART

The disclosed device relates generally to a method and apparatus in the technical field of information management and more particularly, in the technical field of Business Intelligence (BI) as defined by Forrester Research—namely, “a set of methodologies, processes, architectures, and technologies that transforms raw data into meaningful and useful information that's used to enable more effective strategic, tactical, and operational insights and decision-making.”

### BACKGROUND

BI is today broadly recognized as a vital mechanism for companies to provide strategic and operational meaningful information, reports and business figures from the company's many data sources. The process of constructing an environment for BI is regarded as very complex and time consuming. In most cases it highlights both management and technical issues and can therefore be quite overwhelming, especially for medium and small size businesses. The reason for this is that businesses are faced with, on one hand a large set of methodologies, architectures and “best practices” in the market, primarily in form of written books and documents, and on the other hand technologies in the areas of ETL (Extract, Transform, Load) and visualization.

Businesses are left to use the available information and software components to build their own BI environment. This is a challenging task and more often than not leads to project failure in that it exceeds estimated cost, time and complexity. Moreover in these internal built BI solution environments there will normally be no reusability of data sources extractions, ETL processes or solutions across different companies in the market. This is due to the top-down and case-by-case task orientation in building data warehouses, combined with basic functionality of current ETL tools, which makes generalization and reusability difficult.

ETL tools that exist in the market today are rich on functionality, but are made for general purpose. The basic functionality has been around for many years, with limited development and innovation over the last years.

ETL products from most vendors are based on the same idea that ETL processes have to be defined on a very low level and with programmatic dependency control. Further, ETL tools today are to a very limited extent supporting methodologies, architectures and “best practices” for data warehousing and BI.

The major drawbacks with today's ETL tools are the level of detail focus and the need for a user to explicitly define processes and dependencies between them. With some maintenance and integrated new developments over time, the solution becomes extremely complex and almost impossible to maintain any further. When that occurs the solution is often re-engineered from scratch. Such a consolidation will of course be based on a better overall understanding and will therefore make a better foundation for a new and more solid architecture. But after some time with further development it is likely that the complexity will again grow to an overwhelming level.

Visualization tools on the other hand have shown a stunning development and innovation over the last few years, where the latest innovations have brought the market self-service BI, in-memory processing and animated visualizations. In order to perform to their full potential, these tools would benefit from having a solid and quality assured data foundation (like a data warehouse).

It is a well-known fact in the industry that the cost and effort spent on ETL activities and visualization activities in a BI project is split near 80 to 20 percent respectfully. Thus, it becomes apparent the area in which resources should be spent in order to reduce cost and risk in such projects.

### SUMMARY OF THE DISCLOSURE

The disclosed device is a methodology supported BI product. The method and apparatus address several of the challenges with current technology and methodologies by.
Idealizing data source interfaces
   Improving model understandability
   Improving reusability
Implementing “Inline Transformations” by having
   No explicitly defined ETL dependencies
   A combination of natural and derived dependencies
   Automated end-to-end dependency documentation
   Automated and optimized paralleled updating processing

Thus, the disclosed device makes it possible for users to develop, maintain, and operate comprehensive BI environments “out-of-the-box”. Moreover the disclosed device provides users with features to handle the requisite changeability in the relevant BI environment and to benefit from extensive reusability of idealized data source interfaces as well as ETL processes. The disclosed device is based upon Microsoft operating systems and utilizes Microsoft SQL Server as the basic technology platform.

These and other advantages of the disclosed device will appear from the following description and/or appended claims, reference being made to the accompanying drawings that form a part of this specification wherein like reference characters designate corresponding parts in the several views.

### BRIEF DESCRIPTION OF THE DRAWINGS

FIG. 1 depicts a product repository and usage by the product.

FIG. 2 is an overview of one example of a complete data flow from source data to star schema construction including relevant data stores.

FIG. 3 depicts a physical database naming structure.

FIG. 4 shows one embodiment of the basic structure of handling data sources.

FIG. 5 depicts one example of a general database object naming convention used throughout the product.

FIG. 6 depicts the naming standard of surrogate columns of the disclosed device.

FIG. 7 depicts one example of the process for idealizing data sources.

FIG. 8 depicts one example of an extraction process.

FIG. 9 depicts one example of the data flow from a data source to a staging area.

FIG. 10 depicts an example of the data flow from a staging area to an operational data store.

FIG. 11 depicts an example of the process of detecting changes between a repository and an operational data store.

FIG. 12 depicts an example of the general transformation process with an operational data store as the source.

FIG. 13 illustrates the principle of inline transformation using SQL views.

FIG. 14 illustrates an inline transformation data load task in the dependency chain.

FIG. 15 illustrates the basic principle of derived dependencies in a star diagram.

FIG. 16 illustrates the basic principle of defining process groups.

FIG. 17 depicts one example of the infrastructure of a product installation.

Before explaining the disclosed embodiments of the disclosed device in detail, it is to be understood that the disclosure is not limited in its application to the details of the particular arrangements shown, since the method and apparatus is capable of other embodiments. Also, the terminology used herein is for the purpose of description and not of limitation.

### DESCRIPTION OF THE DISCLOSED EMBODIMENTS

The following description is provided to enable any person skilled in the art to make and use the disclosed method and apparatus. Various modifications, however, will remain readily apparent to those skilled in the art, since the generic principles of the present method and apparatus have been defined herein specifically to provide for a methodology supported BI product.

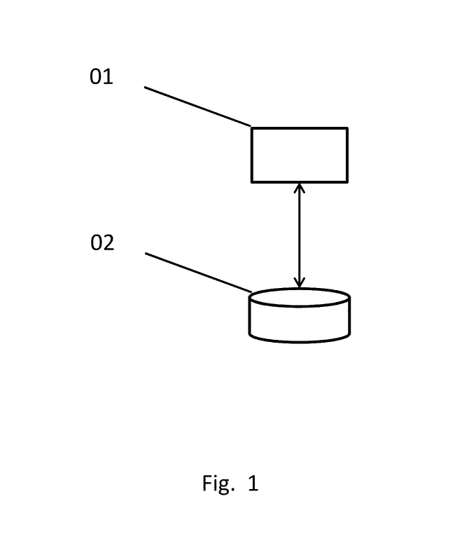

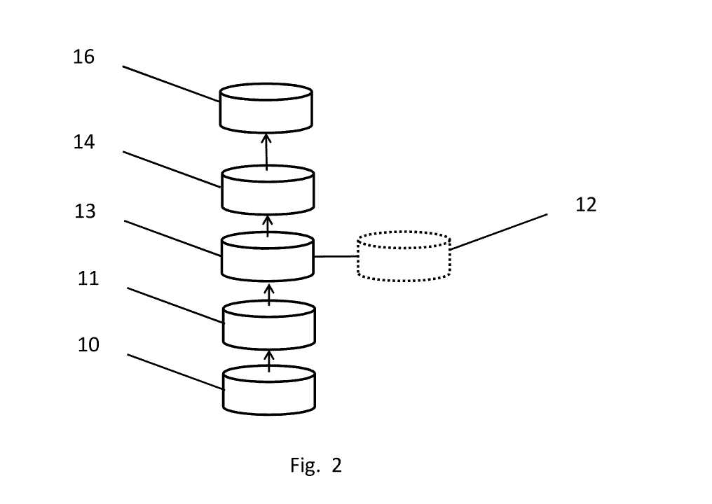

As shown in FIG. 1, product 01 is using its own repository database 02 for most of its persistent management information. FIG. 2 shows one example of the general data flow starting with data sources 10. It is important to note that unlike devices 11 to 16, data sources 10 may exist in as many instances as are relevant for a specific product installation. Device 11 is a physical database that is used as a data staging area. Full or incremental loads from data sources 10 are bulk copied into device/staging area 11 to ensure maximum performance.

Device 12 is a logical surrogate data area that physical resides in operational data store 13. Device/surrogate data area 12 holds conversion tables that reflect the link between original and surrogate keys. For each table, the surrogate key is held in an integer column where the first record starts with the value 0 (where 0 is a dummy record to be used for invalid relationships) and is incremented by 1 for each new original key. One or more data tables are assigned a surrogate key and the surrogate keys are also used in foreign key references.

Operational data store 13 holds data tables with basically the same structure as the source data, but in a much more user friendly format. The overall structure of a data table in operational data store 13 is:

| | | |
|---|---|---|
| Column | 1 | Primary key (surrogate key) |
| Column | 2 | Last Change Date |
| Column | 3 | Instance No |
| Column(s) | 4-n | Foreign surrogate keys if exists |
| Columns | n | Data columns |

If a defined relationship does not have a match in its foreign table, the foreign surrogate key column is given the value of zero. To make sure that relations are resolved in joins between tables, each data table has its own reference record with primary surrogate key value set to 0. If foreign keys exist in this table, the surrogate foreign key columns value is also set to 0.

The ETL process uses operational data store 13 as a source and the transformations are carried out in ETL database 14. The ETL process provides one or more relevant fact and dimensions tables for the next level that is the star schema elements database 16. Star schema database 16 is the level which interfaces with the visualization layer, either directly or via the data mart level 17. The source tables and views reside in ETL database 14 and are made available for star schema database 16 either by using views or tables by using inline transformation principles.

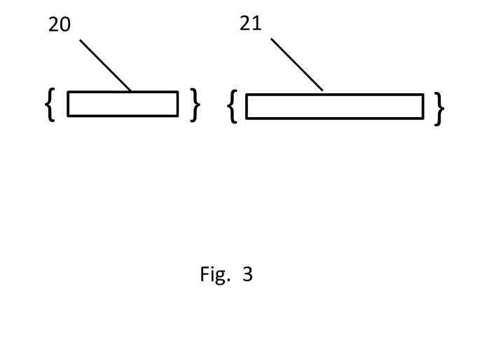

FIG. 3 shows the physical database naming conventions. The database name can consist of two parts, a customizable prefix 20 and a fixed suffix 21. During the installation procedure the user is given the opportunity to specify his or her own prefix 20 or use a default prefix value.

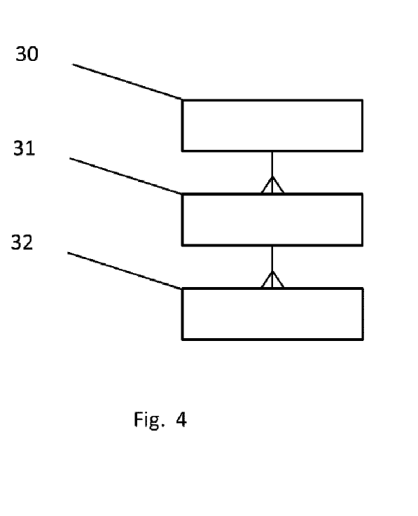

FIG. 4 shows the fundamental structure for handling data sources in the product. Data source level 30 serves solely as a logical grouping of data source versions 31. Data sources versions 31 contain specific database metadata information as well as mapping information that is used to implement friendly names for destination tables in the data warehouse. Data source version 31 can be used in one or more instances 32. This is to serve situations where a user has more than one instance of a source application installed or that he or she wishes to handle logical different clients in a single application separately.

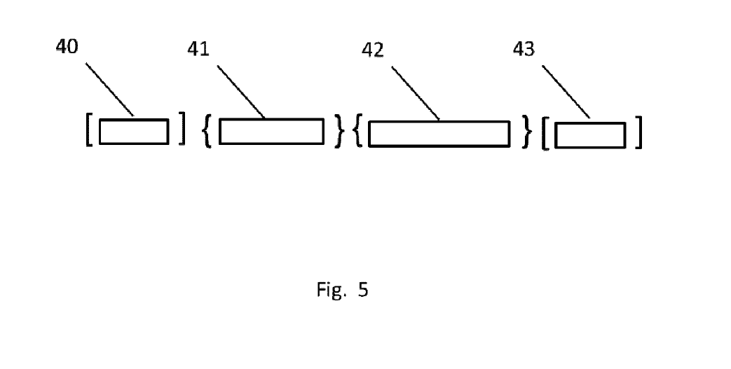

FIG. 5 shows object naming conventions and string sequences for table and view objects used by product 01. The naming is divided into identifying 41, descriptive 42 and classifying 40/43 parts that are combined. The identifying 41 and descriptive 42 parts may be required, while the classifying 40/43 parts are optional. The identifying part 41 is used to visually identify the data source from which the object origin. It could be built as a combined string as follows: Data source name (e.g. SAP), version id and instance id. The product 01 itself creates and maintains the identification part. The descriptive part 42 is a free description that is provided by the user as part of the idealizing process. The classifying parts (prefix 40 and suffix 43) are used for categorizing objects for different purposes like:
Surrogate key conversion tables
Changing dimensions
Snapshot tables

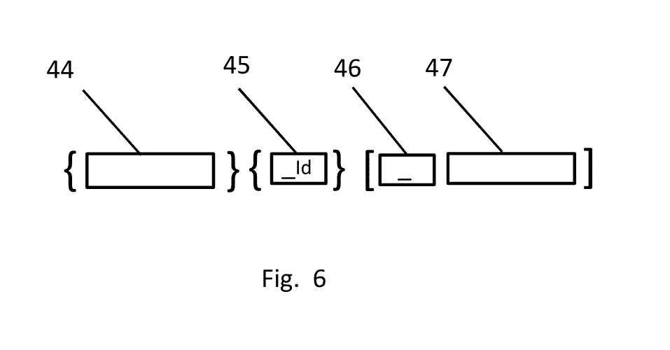

FIG. 6 shows the naming standard of surrogate columns that are imposed by product 01 and illustrates how the naming standard makes it easy to see one or more of the relationships in the idealizing data sources at a glance. For example, surrogate key column 44 contains table name as the column name and “_'Id” 45 as the suffix. This format is used for primary keys as well as foreign keys. A primary key column 44 inherits its name from the table name, while foreign key column(s) inherits its name from the referenced table name. There might be more than one reference from one table to the same foreign table. When that occurs, product 01 supplies an underscore 46 and a role name 47 to the surrogate column name. The role name is built by using the idealized column name(s) from the original key column(s).

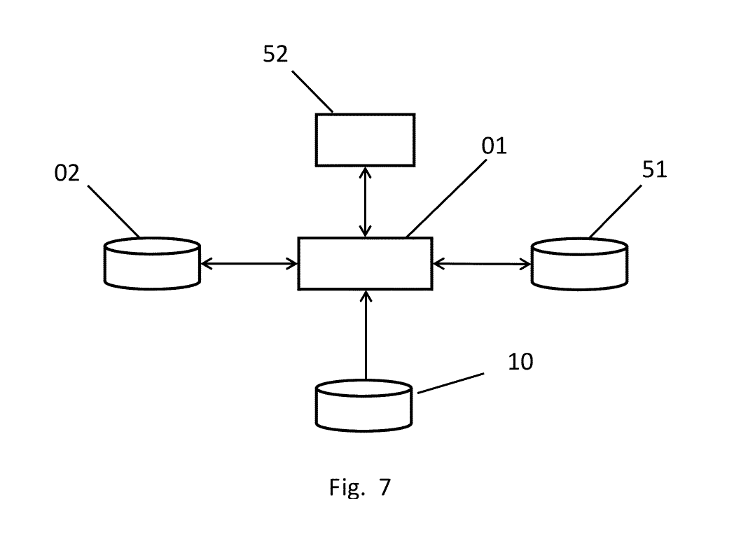

FIG. 7 illustrates the principle of idealizing data sources. Idealizing data sources are defined as the process of, regardless of the original data source, making an operational data model 13 as complete and understandable as possible. The fundamental requirements in the process are to:
Provide intuitive table name mappings for relevant tables
Provide intuitive column name mappings for relevant columns
Complete the relational model with
   All primary keys
   All relevant foreign keys

Product 01 supports the process of idealizing data sources by the following step-by-step process chain.
1. Import original data source 10 metadata into repository 02;
2. Provide intuitive table and column names by mapping friendly names to the original names. This can be done by using internal editors in product 01 or by allowing export and import of the complete metadata model to and from an external format 52.
3. In case the relational model is incomplete, export a complete metadata database 51 for a given data source 10. This metadata database 51 is then completed with necessary primary and foreign keys using standard SQL Server Management Studio. After the completion, the revised metadata database is imported into repository 02.

Product 01 now has the necessary information to provide user friendly names in operational data store 13 and to create surrogate keys in order to visualize relations in an intuitive manner.

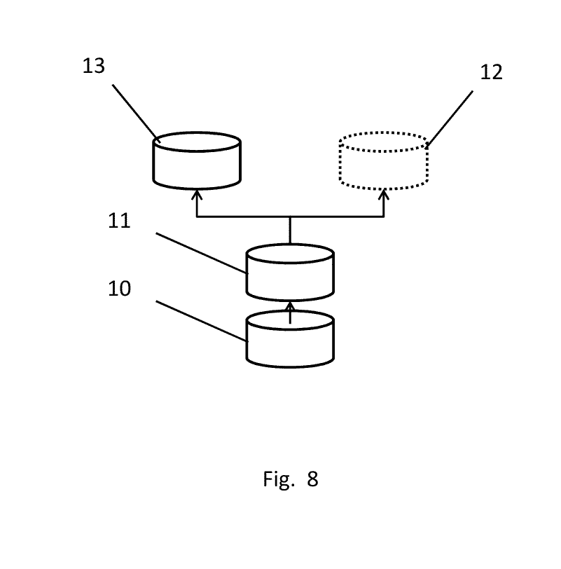

FIG. 8 shows an overview of the extraction process. Here, the data flows from data source 10, via staging area 11 to operational data store 13. The figure also show surrogate data store 12 which might be a part of the physical operational data store 13. The necessary tables are automatically created after the following rules:
Staging data store 11
   Table is dropped and created if it exists, or created if it do not exists
   Table is dropped after successful execution or kept if execution was unsuccessful
Operational data store 13
   Surrogate data store 12
      Table is created if not exists
   Operational data store table
      Table is created if not exists

The load process is multithreaded, and the integrity of the process is ensured by making each table load dependent on whether the specific table foreign key tables are successfully complete before loading.

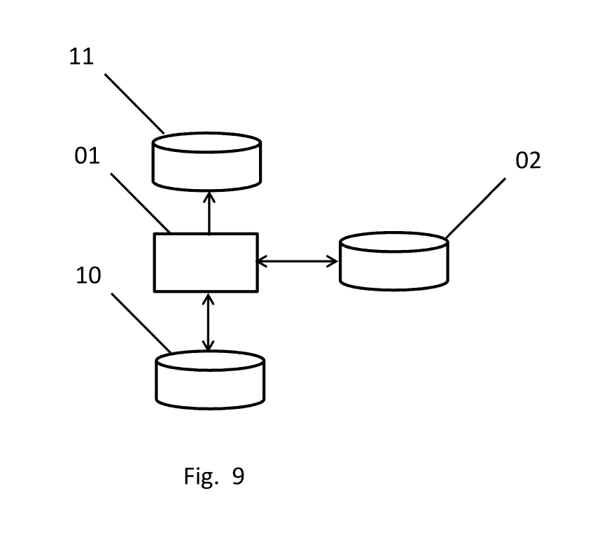

In further detail, FIG. 9 shows how data flows between data source 10 and staging area 11. Staging area 11 is used for full or incremental load of data source tables 10. The structure mirrors the selected tables and columns from data source 10.

Product 01 supports a variety of selection criteria
A filter on specific column names through the complete data source 10 is used for filtering general codes like Client and language codes.
Specific filter(s) on specific tables
Incremental columns like a number, last update data etc.
   The staging area tables are supplied with a data source table's original primary key that is evaluated during the load process. This prevents the importation of duplicate records.

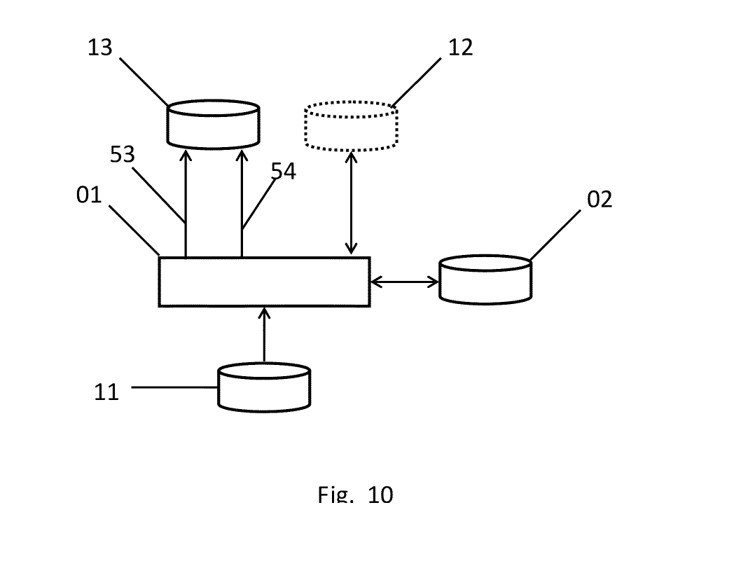

FIG. 10 shows the data flow between staging data store 11 to operational data store 12. During this process, several important functions are performed, specifically, the re-engineering of the destination data model takes place by converting original keys and foreign original key references to integer surrogate keys 12. All tables maintain their own surrogate key 12 table where original keys are mapped to surrogate keys. A surrogate key table's primary key is the integer key, while the original (one or more columns) forms a unique index.

During insert and update operations, the surrogate tables are used to create and maintain surrogate keys for data tables. If a specific original foreign key does not have a corresponding original key value in the surrogate table 11, the integer value zero is used as a default value. The zero value will reference the reference record that is implemented in operational data store 13.

The data processing sequence is determined by the dependencies between tables. Dependency criteria in this setting are determined by foreign keys. This means that no table should be processed unless the tables that are used as foreign keys in the table have successfully updated their respective surrogate key tables first. This ensures that tables extracted from a specific data source 10 are in sync regarding relationships.

Still referring to FIG. 10, the data flow is basically handled in to different streams. Here, the steps comprise:
Updating 54 if the record with actual surrogate primary key exists in the operational data store 13.
Loading 53 if the record with actual surrogate primary key does not exists in the operational data store 13.
   An extra feature for an update 54 stream is to optionally avoid updating if no involved column value in the update stream has actually been changed.

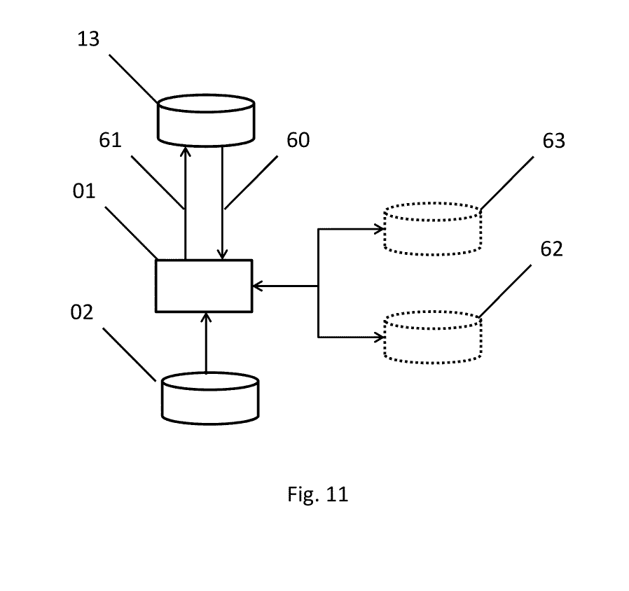

Referring now to FIG. 11 there is shown the principle for changeability. In a dynamic business world, new and changed requirements frequently occur. The data warehouse and BI solution has been shown to be able to comply with and adapt to these changes. Basically the product is designed to automatically cope with many of the normal changes that occur, for example:
New table
Dropped table
Renamed table
New column
Dropped column
Renamed column
New foreign key
Dropped foreign key
Altered data definitions
   To be able to handle one or more of the mentioned scenarios, it is necessary to implement a static reference model. This is because one or more of the normal references basically can be changed. The static reference model is established and maintained by using SQL Server extended properties in the operational data store 13 data tables. On the table level, one extended property contains data source 10 table names. On the column level, one extended property per column is supplied by the product 01, but with a bit more complex naming structure:
Primary surrogate key column gets the static value ‘PK’
Foreign surrogate key columns get the value of the correspondent external foreign key name
Ordinary columns get the corresponding data source table 10 column names.

The product 01 performs consistency check by comparing the repository 02 definitions with the operational data store 13 definitions. If any discrepancies are found a corrective script is built and optional executed by the product 01. This functionality enables the possibility of changing the data import dynamically without having a manual overhead of reconstructing the operational data store 13.

In more detail the process consists of the following steps:
1. Product 01 extracts definitions from repository 02 and produces an intermediate internal table 62
2. Product 01 extracts definitions from operational data store 60 and produces an intermediate internal table 63
3. Two tables 62 and 63 are then joined by using data source 10 definitions combined with the special case columns that are explained above.
4. A discrepancy script is created if any inconsistencies have been found.
5. The script is optionally executed 61.

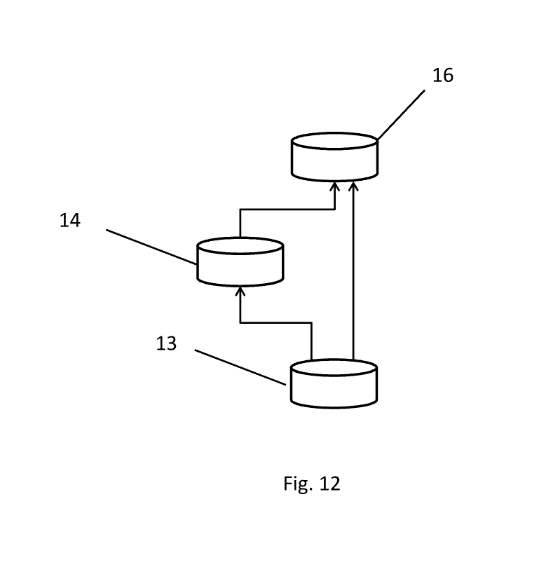

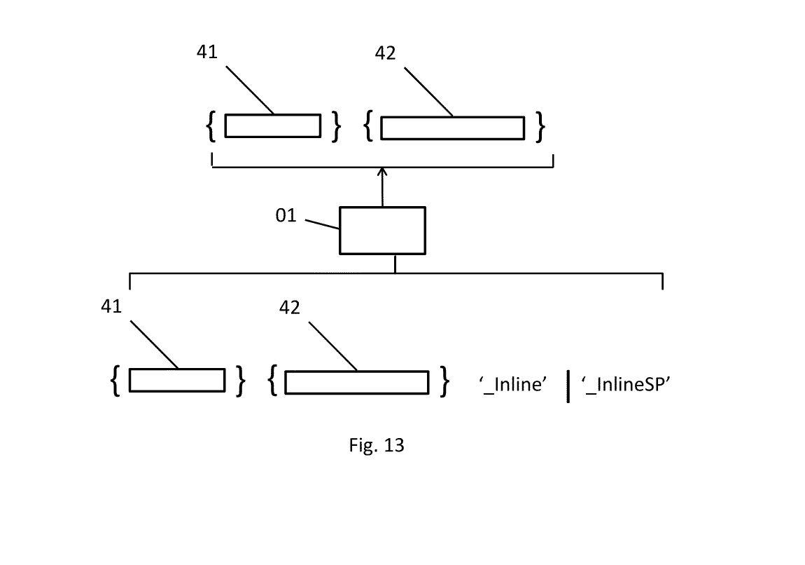

FIG. 12 and FIG. 13 illustrate the principle of transformation. Given the re-engineering of data source 10 in operational data store 13, with consistent surrogate key based model, in many cases there will no need for transformations at all. Tables can serve directly as dimension and fact tables in star schema database 16. If transformations are needed, the process could be viewed as a series of dependent views in ETL data store 14 that are continuously refining the data into its ultimate dimension or fact table in star schema database 16. However, view based dependency chains clearly have their limitations both when it comes to performance and also when very complex transformations should be performed.

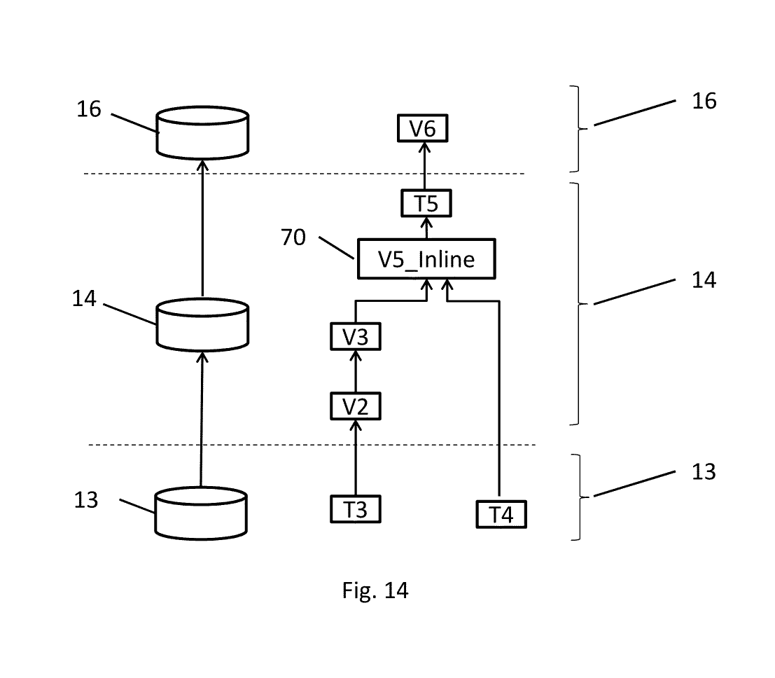

Product 01 solves these issues by allowing a specification of inline transformation objects (see FIG. 14, example 70). The specification uses basic SQL Views as logic carriers. Moreover, the specification allows for activating stored procedures as well as basic SQL views.

The inline transformation functionality ensures that ETL processes are included in a manageable global unbroken dependency structure across databases in the BI solution. The unbroken dependency chain is used for several purposes in product 01, for example:
1. An automated end-to-end dependency documentation.
2. An interactive visualization of dependencies for developers.
3. Dynamic multitasked, prioritized and parallelized execution of defined ETL tasks.
4. Detection objects not referenced/not in use

Referring now to FIGS. 13, 14, there is shown the detailed principle for data load tasks. When there is a need for loading data into tables in the ETL/ELT process, a pre-defined naming convention and structure is used so that product 01 recognizes the need for actions. Technically, it is done by providing a suffix that is either “_Inline” for including a view, or “_InlineSP”, for example, for including a stored procedure in the inline transformation functionality. The output from both is a physical table, where the table name is inherited from the source (view) name, but with the suffix (“Inline”/“InlineSP”) removed. Product 01 handles the technical configurations of this functionality by having the options include or exclude from inline transformation table generation functionality. This technique allow for flexible transformation processes. The following detailed rules apply to each type of data load:
“_Inline”—data loads comprise a primary key specification. The specification of a primary key is done by using the “order by” statement in the SQL view. All columns that are included in the “order by” statement will be regarded as primary key in the destination table definition. As a precaution, in case of future changes in SQL rules in this area, primary key columns along with other parameters can also be stored in the product's 01 repository 02.

Further, a generation of a surrogate key can be enabled in two variations, and are technically implemented as follows:
1. A zero value followed with an alias column name with the suffix “_Id_Ic” signals incremental load, meaning that only records with primary key that do not exist from before, will be loaded. The alias column name “_Id_Ic” will be an identity column and renamed to “_Id_I” in the destination table definition.
2. A zero value followed with an alias column name with the suffix “_Id_Ix” signals that the table will be reloaded from scratch during every process. The alias column name “_Id_Ix” will be an identity column and renamed to “_Id_X” in the destination table definition.

Product 01 creates the destination tables in ETL database 14. Product 01 also detects one or more structural changes between the view and the destination table. In such cases an optionally drop and recreate of the associated destination table is offered interactively.
“_InlineSP”—unlike data loads from a standard view, a “_InlineSP” view signals a view that acts as a dependency structure placeholder. A stored procedure can be included in the inline transformation functionality when it contains the following parameters (parameter names are subject to change over time):

### Required

@XBI_DestinationTableName (will be the destination table name) Optional (return parameters for logging error messages and load details)

@XBI_RowsInserted

@XBI_RowsUpdated

@XBI_RowsDeleted

@XBI_ErrorMessage

In addition to the pre-defined parameters specified above, the store procedure might use its own specific parameters. The stored procedure view is technically constructed as follows:

| | | |
|---|---|---|
| Column | 1 | String containing the name of the stored procedure - any |
| | | alias column name |
| Column | 2 | String containing stored procedure specific parameter list |
| | | with values separated with a delimiter |

### Example

| | |
|---|---|
| ‘MyProcedure’ | AS ProcedureName, |
| ‘MyParm1 = “x”, ‘MyParm2 = “y”’ | AS SpParm |

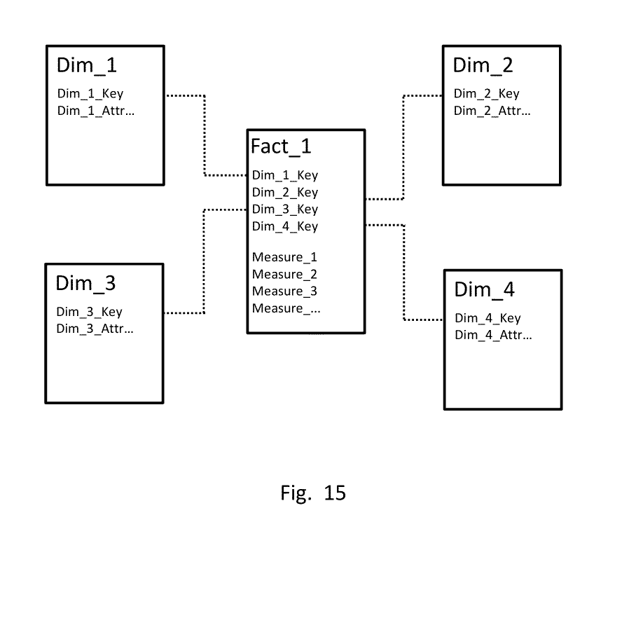

In order to make the dependency chain completed for stored procedures, product 01 provides a facility to register the object names that the stored procedure is dependent on.
Product 01 installs a default database structure, which includes three standard data databases to be used in the Inline Transformation data loads:
Operational data store 13
Transformation data store 14
Star schema database 16
   However, there is no limitation on adding additional databases to the inline transformation structure as long as the defined star schema database 16 holds the logical top level info in the object dependency chain. Star schema database 16 should hold logical fact tables and dimension tables as shown in FIG. 15 Data marts might utilize the star schema database 16 objects for isolating specific reporting areas.

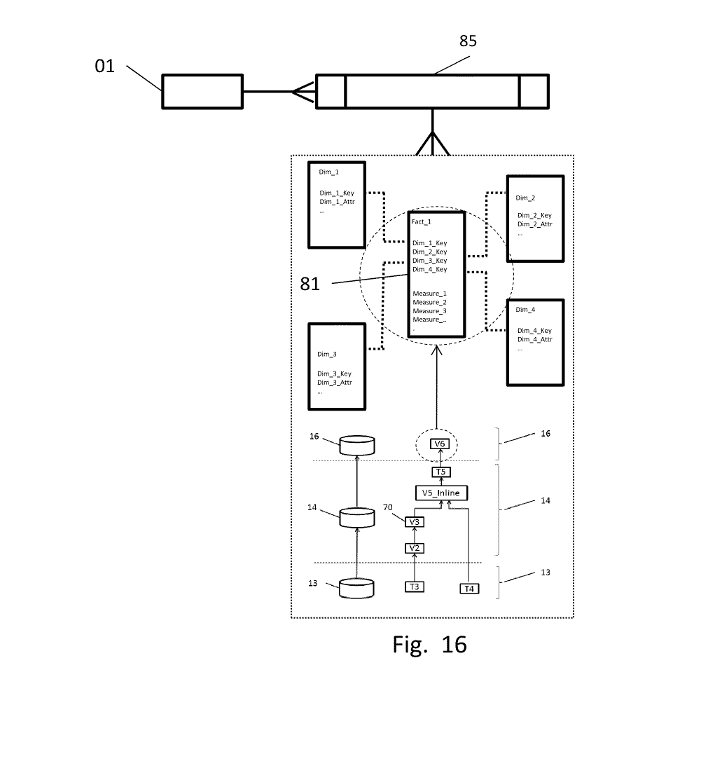

Referring now to FIGS. 15 and 16, product 01 allows for flexible data update schedules to be configured by defining active solution objects as:
Fact table or view objects 81 in star schema database 16
   Fact table or view objects 81 are normally dependent on one or more dimension table or view objects 82. This is reflected by the product 01 as derived dependencies. The technique used here establishes fact tables in star schema database 16 as the top level of the dependency chain and allows for flexible transformations based on selecting one or more fact table or view objects 81 for processing.

Only active solution objects can be scheduled for updates in the ETL/ELT process. The derived dependency configurations of these objects are done automatically by the product 01 based on naming convention, but are to be approved by the solution developer through the product.

Product 01 structures the objects included in the defined solution databases in a continuous dependency chain. This is done dynamically and continuously as the solution changes and expands. As it dynamically and automatically reflects the actual physical defined or derived dependencies in the database, the solution developer does not need to manual specify logical dependencies between objects or structures when making alterations or adding objects to the structure.

Scheduling updates are done through running updates on defined process groups 85, which can either use the default ‘All’ group that is included in product 01, which contains fact table or view objects 81 defined in star schema database 16, or by specifying user defined process groups. Process groups are defined in product 01 by including at least one active solution fact table object (see FIG. 16, object 81). By including one of these objects, derived dependency objects 82 and lower level objects 70 in the dependency structures are included in the update. When including more than one active solution fact table object 81 in the group, product 01 will combine the data load processes of the hierarchical dependencies and ensure that an executable object is executed once although it is referenced by several processes higher in the dependency chain. Product 01 assures the correct execution sequence is implemented by utilizing the established dependency chain. Product 01 also utilizes the established dependency chain to dynamically control parallelization of data transformations and achieve the best possible performance through that mechanism.

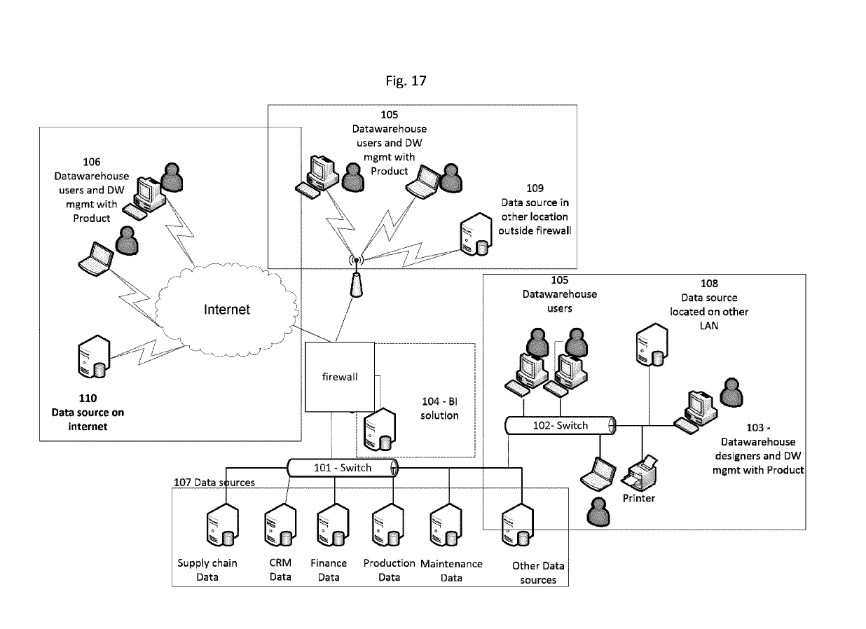

FIG. 17 shows an example of a Product 01 installation. In this embodiment, the BI solution environment resides in database server 104. Product 01 extracts data from various data sources 107, 108, 109, 110 on the network. Users 103, 105, 106 of Product 01 who are data warehouse designers and/or architects can reside anywhere within the network.

A method of transforming raw electronic data which is stored in a first application data model into a second data model and loading data into said second data model is disclosed. The method comprises the steps of (i) defining an idealized data model for at least one data source and (ii) processing an idealized data model for at least one data source by converting a first data model into a second relational data model. The defining step comprises: importing metadata from said data source into a product; refining data model keys and relationships in said product if necessary; and improving and/or selecting one or more new table- and column-names capable of defining said idealized data source. The processing step comprises converting one or more original data source keys and relationships to a surrogate key-based model by creating at least one destination table with an idealized name format; creating a surrogate key conversion table for each destination table; and importing data through a parallel processing of the destination tables.

The importation of metadata comprises an importing of tables, table names, column names, keys and relationships if information exists in a DBMS system. If information exists in a data source application repository, the importation of metadata comprises an importing of table and column descriptions, key and relationship definitions. Refinement of data model keys and relationships comprises an exporting of the data model to an empty metadata database, maintaining the data model definition using one or more standard DBMS features in creating a refined metadata model, importing the refined metadata model into a product again. Each of the refining steps is capable of being performed as an iterative process and at any time.

Improving and/or selecting of new table- and column-names comprises an editing of names directly in the product or exporting table and column definitions into an external standardized format, maintaining the table and column names in the external standardized format, and importing the definitions into product again. Each of the improving and/or selecting steps is capable of being performed as an iterative process and at any time.

The creation of the at least one destination table comprises selecting an idealized table name that is prefixed by a data source name, version number and instance number automatically defined in the product, and one or more idealized column names. The one or more idealized column names comprises a primary key column which is a surrogate key column inheriting its name from the idealized table name and comprising a data type integer, and if more than one reference is associated with the same table, a suffix comprising original foreign key column(s) having said defined idealized column name.

The creation of a surrogate key conversion table for each data table comprises idealizing a table name with a defined naming structure to separate it from each of the data tables and selecting an idealized column name having a surrogate key column name inheriting its name from the idealized table name and which comprises a integer and an original key column inheriting its name from the defined idealized column name and which comprises a data type from the data source. The importation of data through a parallel processing comprises dividing a data stream into an insert- and/or an update stream, executing data loads in a logical order as derived from the data model relationships, and creating and/or updating surrogate key tables during a load process, each of the data tables dependent on a successful processing of its surrogate key tables and/or its tables that are referenced as a foreign key.

The defining step further comprises the establishing of import filters and selection criteria from one or more or none of incremental rules for table load with or without overlapping records, one or more column level selection criteria for each table, global data source selection criteria and column level functions to manipulate data on row level.

Disclosed is also a method of ensuring consistency between a configured product repository and a destination operational data store when changes to one or more configurations occurs. The method comprises the steps of creating and maintaining a static reference model which further comprises a storing of object information in one or more object extended properties in the operational data store and comparing one or more repository configurations and definitions with one or more extended properties in the static reference model. On a table level, the storing of object information comprises at least one extended property containing a data source table. On a column level, the storing of object information comprises at least one extended property per column created using a primary surrogate key having a static standardized value, a foreign surrogate key having a value of a corresponding external foreign key name, and ordinary columns having a corresponding data source column name. The comparing of one or more repository configurations and definitions comprises extracting definitions from the repository and producing a first intermediate internal table, extracting definitions from the operational data store and producing a second intermediate internal table, comparing the first and second intermediate internal tables, creating a discrepancy script if inconsistencies are found, and displaying the discrepancies to a user along with a repair script that optionally can be executed.

In addition, a method of constructing an unbroken dependency chain for all data transformation tasks in a data warehouse, information management and/or business intelligence (hereinafter “a solution”) environment is disclosed. The method comprises the steps of: (i) establishing a naming format for database objects comprising one or more tables or views for a data transformation processes, (ii) standardizing the solution environment by incorporating at least three standardized databases, a first database holding an idealized data source, a second database holding one or more transformation processes, a third database holding a multidimensional star diagram structure to be accessed by an end user visualization application, (iii) creating the unbroken dependency chain by structuring and storing information in said standardized databases, wherein one or more physical dependencies are extracted from at least one DBMS system table into a dependency structure within said product, and (iv) defining and scheduling flexible update processes in the product by using a dynamic unbroken dependency chain. This step is implemented by defining logical dependencies on one or more top level objects within the multidimensional structure, defining processing groups by using one or more fact table objects as input, dynamically creating and maintaining a complete list of objects to be automatically included in an update process via the dependency structure, and loading data by parallel processing of all objects on the same level in the dependency structure to automatically maximize performance efficiency.

Each of the tables or views are includable in the unbroken dependency chain via naming and format standardization which can be specified in a product. One or more dependencies that are derived from the standardized naming convention promoted by the product are includable in the dependency structure within the product, the product enabling a defining of logical dependencies or relationships in the product and storage of the dependency structure within the product. The step of establishing a naming format for database objects comprises a deriving of a destination table name from the view name, a specifying a primary key column and an optional surrogate key column through the product or by a standardized format in database view, and an optional loading of full data or incremental data through the product or by a standardized format in database view. The database objects in the name establishing step comprise one or more stored procedures having a view format comprising a destination table name and an associated view parameter. The one or more stored procedures are dynamically referable to the destination table and the associated view parameter. The one or more stored procedures are capable of being automatically loaded into said one or more tables.

Disclosed herein is a method to transform raw electronic data into meaningful and useful information. The method comprises idealizing metadata from at least one data source into a relational model, comprising, importing metadata into a repository connected to a product, generating intuitive table and column names by mapping a friendly name to an original name by the product, refining the metadata to include table keys and relationships even if this information may not be accessible in the data source.

The method also comprises importing table(s) primary key(s) from the staging data store to a surrogate data store creating a surrogate key table, wherein the surrogate data store converts all original keys and foreign key references to surrogate keys, an original key being mapped to a surrogate key, the surrogate key table reflecting the link between the original and surrogate keys. During insert and update operations the surrogate key tables are used to create and maintain surrogate keys.

The method also comprises processing the table for extraction to an operational data store, wherein the table can successfully update the surrogate key table before processing, the table being updated during processing if a record with an actual surrogate primary key exists in the operational data store, the table being loaded if a record with the actual surrogate primary key does not exist in the operational data store. The method also comprises importing data to said operational data store, wherein the table has to successfully update the corresponding surrogate key table and the surrogate key table(s) of any related tables before processing; and performing a consistency check on metadata level by comparing the repository with the operational data store.

The idealizing step comprises exporting a metadata database to provide primary and foreign keys using standard DBMS functionality, and wherein a revised metadata database is imported back into said repository where it can be iteratively refined one or more times, the relational model being a reusable object that can be purchased as a commodity. The idealizing step further comprises establishing user-crafted user-selected table name mappings and user-crafted user-selected column name mappings which can be set forth in an external spreadsheet exported by the system, the system disposed to read the spreadsheet and to bring about the associations with respect to the tables in response to the content of the spreadsheet.

The check performing step further comprises creating a first intermediate internal table extracting data from the repository, creating a second intermediate internal table extracting data from the operational data store, joining the first and second intermediate internal tables, creating a discrepancy script if any inconsistencies are found, exporting the operational data store table directly to a star schema database if discrepancies are not found, and exporting the operational data store table to a ETL data store to refine the table and export the table to the star schema database if discrepancies are found.

A system for transforming raw electronic data which is stored in a first application data model into a second data model and loading data into said second data model is also disclosed. The system comprises an idealized data model for at least one data source, the idealized data model comprising imported metadata from the data source, refined data model keys and relationships, and one or more new table- and column-names capable of defining said idealized data source, the idealized data model for at least one data source capable of converting a first data model into a second relational data model; one or more original data source keys and relationships convertable to a surrogate key-based model through the creation of at least one destination table with an idealized name format; at least one surrogate key conversion table for each destination table; and data imported through a parallel processing of the destination tables.

The system comprises an empty metadata database, capable of receiving exported data from the data model and maintaining a data model definition, a refined metadata model created from one or more standard DBMS features which can be imported into a product, the refined metadata model capable of being generated iteratively. The at least one destination table comprises an idealized table name that is prefixed by a data source name, version number and instance number automatically defined in a system product, and one or more idealized column names.

One or more idealized column names comprise a primary key column which is a surrogate key column inheriting its name from the idealized table name and comprising a data type integer, a foreign key column which is a foreign surrogate key column inheriting its name from the related table name and comprising a data type integer, and if more than one reference is associated with the same table, a suffix comprising original foreign key column(s) having said defined idealized column name. The surrogate key conversion table for each data table further comprises a table name with a defined naming structure to separate it from each of the data tables and an idealized column name having a surrogate key column name inheriting its name from the idealized table name and which comprises a integer and an original key column inheriting its name from the defined idealized column name and which comprises a data type from the data source.

The system further comprises a data stream capable of being divided into an insert- and/or an update-stream and one or more data loads executable in a logical order as derived from the data model relationships. In addition, the system comprises import filters and selection criteria from one or more or none of incremental rules for table load with or without overlapping records, or from one or more column level selection criteria for each table, or from global data source selection criteria and column level functions to manipulate data on a row level.

Although the disclosed device and method have been described with reference to disclosed embodiments, numerous modifications and variations can be made and still the result will come within the scope of the disclosure. No limitation with respect to the specific embodiments disclosed herein is intended or should be inferred.

I claim:

1. A method of ensuring consistency between a configured product repository and a destination operational data store when changes to one or more configurations occurs, said method comprising the steps of:
creating and maintaining a static reference model further comprising a storing of object information in one or more object extended properties in said operational data store; on a table level, at least one extended property containing a data source table; on a column level, at least one extended property per column created using a primary surrogate key having a static standardized value, a foreign surrogate key having a value of a corresponding external foreign key name, and ordinary columns having a corresponding data source column name; and
comparing one or more repository configurations and definitions with one or more extended properties in said static reference model.

2. The method of claim 1, wherein said comparing of one or more repository configurations and definitions further comprises extracting definitions from said repository and producing a first intermediate internal table, extracting definitions from said operational data store and producing a second intermediate internal table, comparing said first and said second intermediate internal tables, creating a discrepancy script if inconsistencies are found, and displaying said discrepancies to a user along with a repair script that optionally can be executed.

3. A method of constructing an unbroken dependency chain for all data transformation tasks in a data warehouse, information management and/or business intelligence (hereinafter “a solution”) environment, said method comprising the steps of:
(i) establishing a naming format for database objects comprising one or more tables or views for a data transformation process, each of said tables or views includable in said unbroken dependency chain via naming and format standardization which can be specified in a product;
(ii) standardizing said solution environment by incorporating at least three standardized databases, a first database holding an idealized data source, a second database holding one or more transformation processes, a third database holding a multidimensional star diagram structure to be accessed by an end user visualization application
(iii) creating said unbroken dependency chain by structuring and storing information in said standardized databases, wherein one or more physical dependencies are extracted from at least one DBMS system table into a dependency structure within said product, one or more dependencies that are derived from said standardized naming convention promoted by said product includable in said dependency structure within said product, said product enabling a defining of logical dependencies or relationships in said product and storage of said dependency structure within said product; and
(iv) defining and scheduling flexible update processes in said product by using a dynamic unbroken dependency chain by defining logical dependencies on one or more top level objects within said multidimensional structure, defining processing groups by using one or more fact table objects as input, dynamically creating and maintaining a complete list of objects to be automatically included in an update process via said dependency structure, and loading data by parallel processing of all objects on the same level in said dependency structure to automatically maximize performance efficiency.

4. The method of claim 3, wherein said step of establishing a naming format for database objects further comprises a deriving of a destination table name from said view name, a specifying a primary key column and an optional surrogate key column through said product or by a standardized format in database view, and an optional loading of full data or incremental data through said product or by a standardized format in database view.

5. The method of claim 3, wherein said database objects in said name establishing step further comprise one or more stored procedures, said one or more stored procedures having a view format comprising a destination table name and an associated view parameter, said one or more stored procedures being dynamically referable to said destination table and said associated view parameter.

6. The method of claim 3, wherein said one or more stored procedures is capable of being automatically loaded into said one or more tables.

7. A method to transform raw electronic data into meaningful and useful information, comprising:
idealizing metadata from at least one data source into a relational model, comprising, importing metadata into a repository connected to a product, generating intuitive table and column names by mapping a friendly name to an original name by the product, refining the metadata to include table keys and relationships even if this information may not be accessible in the data source;
importing data from the at least one data source to a staging data store for temporary storage;
importing table(s) primary key(s) from the staging data store to a surrogate data store creating a surrogate key table, wherein the surrogate data store converts all original keys and foreign key references to surrogate keys, an original key being mapped to a surrogate key, the surrogate key table reflecting the link between the original and surrogate keys, wherein during insert and update operations the surrogate key tables are used to create and maintain surrogate keys;
processing the table for extraction to an operational data store, wherein the table can successfully update the surrogate key table before processing, the table being updated during processing if a record with an actual surrogate primary key exists in the operational data store, the table being loaded if a record with the actual surrogate primary key does not exist in the operational data store;
importing data to said operational data store, wherein the table has to successfully update the corresponding surrogate key table and the surrogate key table(s) of any related tables before processing; and
performing a consistency check on meta data level by comparing the repository with the operational data store.

8. The method of claim 7, wherein the idealizing step further comprises exporting a metadata database to provide primary and foreign keys using standard DBMS functionality, and wherein a revised metadata database is imported back into said repository where it can be iteratively refined one or more times, the relational model being a reusable object that can be purchased as a commodity.

9. The method of claim 7, wherein the idealizing step further comprises establishing user-crafted user-selected table name mappings and user-crafted user-selected column name mappings which can be set forth in an external spreadsheet exported by the system, the system disposed to read the spreadsheet and to bring about the associations with respect to the tables in response to the content of the spreadsheet.
